(19) United States
(12) Patent Application Publication
(10) Pub. No.: US 2025/0196699 A1
(43) Pub. Date: Jun. 19, 2025

(54) ADAPTER, ABNORMALITY DETECTION METHOD FOR ADAPTER, AND ELECTRIC POWER SUPPLY SYSTEM

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventors: Nobuhiro KIBUDERA, Osaka-shi, Osaka (JP); Tatsuya ANKYU, Osaka-shi, Osaka (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 18/847,692

(22) PCT Filed: Mar. 22, 2022
(86) PCT No.: PCT/JP2022/013133

§ 371 Date: Sep. 17, 2024

(51) Int. Cl. B60L 53/68; B60L 53/16

(52) U.S. Cl. CPC B60L 53/68; B60L 53/16; B60L 2240/36

(57) ABSTRACT

An adapter of the disclosure is an adapter that is disposed between an electric power supply connector of a charging stand and an inlet for electric power supply included in a vehicle in which a battery is installed, the adapter connecting the electric power supply connector and the inlet, the adapter including: electric-power-receiving terminals connected to electric power lines of the electric power supply connector; a signal line that connects the charging stand and a control device on the vehicle side via the electric power supply connector and the inlet, respectively; temperature sensor that detect temperatures of the electric-power-receiving terminals; and an error generation unit that generates, in the signal line, a state detectable by the control device in accordance with outputs of the temperature sensors.

### TECHNICAL FIELD

The present disclosure relates to an adapter, an abnormality detection method for an adapter, and an electric power supply system.

### BACKGROUND ART

Patent Literature 1 discloses an adapter that includes a socket to which an electric power supply connector of a charging stand conforming to the CHAdeMO standard (registered trademark) is connectable, and a connector connectable to an inlet of a vehicle conforming to the combined charging system (CCS) standard, the adapter connecting the charging stand and the vehicle in a chargeable manner.

### CITATION LIST

### Patent Literature

PATENT LITERATURE 1: Japanese Laid-Open Patent Publication No. 2017-229230

### SUMMARY OF THE INVENTION

An adapter according to an aspect of the present disclosure is an adapter that is disposed between an electric power supply connector of a charging device and an inlet for electric power supply included in a vehicle in which a storage battery is installed, the adapter connecting the electric power supply connector and the inlet, the adapter including: an electric-power-receiving terminal connected to an electric power line of the electric power supply connector; a connection line that connects the charging device and a device on a side of the vehicle via the electric power supply connector and the inlet, respectively; a detection unit that detects a temperature of the electric-power-receiving terminal; and an error generation unit that generates a state, detectable by the device on the vehicle side, in the connection line in accordance with an output of the detection unit.

Another aspect of the present disclosure is an abnormality detection method for an adapter that is disposed between an electric power supply connector of a charging device and an inlet for electric power supply included in a vehicle in which a storage battery is installed, the adapter connecting the electric power supply connector and the inlet. The adapter includes: an electric-power-receiving terminal connected to an electric power line on the electric power supply connector side; a connection line that connects the charging device and a device on a side of the vehicle via the electric power supply connector and the inlet, respectively; and a detection unit that detects a temperature of the electric-power-receiving terminal. The abnormality detection method includes: detecting the temperature of the electric-power-receiving terminal via the detection unit in a state where the adapter is connected to the electric power supply connector and the inlet; and generating a state, detectable by the device on the vehicle side, in the connection line in accordance with the temperature detected by the detection unit.

Another aspect of the present disclosure is an electric power supply system. The electric power supply system includes: a charging device including an electric power supply connector; a vehicle including a storage battery and an inlet for electric power supply, and the adapter described above that connects the electric power supply connector and the inlet.

### BRIEF DESCRIPTION OF DRAWINGS

FIG. 1 is a diagram illustrating an example of an electric power supply system.

FIG. 2 is a diagram illustrating a configuration of an adapter according to a first embodiment.

FIG. 3 is a view illustrating the main part in FIG. 2.

FIG. 4 is a view illustrating the main part of an adapter according to a second embodiment.

### DETAILED DESCRIPTION

### Problems to be Solved by Present Disclosure

The inlet of the vehicle includes an electric-power-receiving terminal connected to the electric power line of the electric power supply connector.

A temperature sensor is generally provided at the electric-power-receiving terminal on the vehicle side, and a process to stop charging may be executed when a temperature abnormality occurs in the electric-power-receiving terminal.

Here, the socket of the adapter of the conventional example to which the electric power supply connector of the charging stand is connected also includes an electric-power-receiving terminal connected to the electric power line of the electric power supply connector.

When the charging stand and the vehicle are connected using the adapter of the conventional example, the temperature sensor is provided at the electric-power-receiving terminal of the inlet of the vehicle, but the electric-power-receiving terminal of the adapter has no means for detecting a temperature abnormality.

However, even if the temperature sensor is provided in the adapter, leading out the wiring is not easy, and routing the wiring is complex. In addition, since the charging stand or the vehicle side does not have a function of receiving the output of the temperature sensor provided in the adapter, charging cannot be stopped when a temperature abnormality occurs. To stop charging, it is necessary to separately provide, on the charging stand or the vehicle side, a device for receiving the output of the temperature sensor provided in the adapter and stopping charging. That is, it is necessary to change the configuration on the charging stand or the vehicle side to a configuration corresponding to the adapter provided with the temperature sensor. Such a change is not easy.

Therefore, when the adapter of the conventional example is used, it is desirable to provide means for detecting a temperature abnormality of the electric-power-receiving terminal connected to the electric power line of the electric power supply connector without changing the configuration of the charging device, such as the charging stand, and the vehicle side.

### Advantageous Effects of Present Disclosure

According to the present disclosure, it is possible to detect a temperature abnormality of the electric-power-receiving terminal connected to the electric power line of the electric power supply connector without changing the configuration of the charging device and the vehicle side.

### Description of Embodiments of Present Disclosure

(1) An adapter according to an embodiment is an adapter that is disposed between an electric power supply connector of a charging device and an inlet for electric power supply included in a vehicle in which a storage battery is installed, the adapter connecting the electric power supply connector and the inlet, the adapter including: an electric-power-receiving terminal connected to an electric power line of the electric power supply connector; a connection line that connects the charging device and a device on a side of the vehicle via the electric power supply connector and the inlet, respectively; a detection unit that detects a temperature of the electric-power-receiving terminal; and an error generation unit that generates a state, detectable by the device on the vehicle side, in the connection line in accordance with an output of the detection unit.

With the above configuration, when a temperature abnormality of the electric-power-receiving terminal is detected based on an output of the detection unit, a state detectable by the device on the vehicle side can be generated in the connection line, and the device on the vehicle side can be caused to detect that a temperature abnormality has occurred in the electric-power-receiving terminal.

As a result, it is possible to detect a temperature abnormality of the electric-power-receiving terminal connected to the electric power line of the electric power supply connector without changing the configuration of the charging device and the vehicle side.

(2) In the adapter, preferably, the connection line includes a signal line to which a notification signal is provided to notify the start and stop of charging, the notification signal being transmitted from the charging device to the device on the vehicle side.

When the notification signal is interrupted, the device on the vehicle side executes a charging stop process.

Therefore, when a temperature abnormality of the electric-power-receiving terminal is detected based on an output of the detection unit, the notification signal can be interrupted by bringing the connection line into an open-circuit state, and the device on the vehicle side can be caused to execute the charging stop process.

(3) In the adapter, preferably, the error generation unit includes a switch to interrupt the connection line and generates an open-circuit state, detectable by the device on the vehicle side, in the connection line by bringing the switch into an open state in accordance with an output of the detection unit.

In this case, an open-circuit state can be generated in the connection line by disconnecting the connection line by the switch.

(4) In the adapter, preferably, the switch includes a semiconductor switch.

This can increase the operation speed of the switch, thereby quickly bringing the switch into an open state in accordance with the output of the detection unit. The semiconductor switch may be a normally-on type semiconductor switch.

In this case, when the semiconductor switch is provided on the connection line, the conduction state of the connection line can be maintained without applying a drive voltage to the semiconductor switch. In addition, it is possible to suppress electric power consumption in the case of maintaining the conduction state, which is a state that should originally be. Moreover, by connecting the adapter to the electric power supply connector and the inlet, the adapter can connect the electric power supply connector and the inlet in a chargeable manner even if the driving voltage is not applied to the semiconductor switch for some reason.

(5) In the adapter, preferably, the detection unit includes a thermistor, the error generation unit further includes a comparator that compares an output voltage of the thermistor with a predetermined threshold voltage, and when the output voltage of the thermistor becomes larger than the predetermined threshold voltage, the comparator operates the switch to disconnect the connection line.

In this case, when the temperature of the electric-power-receiving terminal becomes higher than a temperature corresponding to the predetermined threshold voltage, the switch can be operated to disconnect the connection line.

(6) The adapter may further include a notification unit that outputs a notification regarding a temperature abnormality of the electric-power-receiving terminal to an external device when the switch operates to disconnect the connection line.

In this case, the temperature abnormality of the electric-power-receiving terminal can be notified to the outside.

(7) In the adapter, the notification unit may include a wireless transmission unit that wirelessly transmits the notification to the external device.

(8) In the adapter, when the electric power supply connector and the inlet each have a different standard, and the adapter further includes a first connection connectable to the electric power supply connector and a second connection connectable to the inlet, the adapter may connect the electric power supply connector and the inlet, each having a different standard, between the first connection and the second connection.

In this case, the adapter can be used as a conversion adapter.

(9) An abnormality detection method according to another embodiment is an abnormality detection method for an adapter that is disposed between an electric power supply connector of a charging device and an inlet for electric power supply included in a vehicle in which a storage battery is installed, the adapter connecting the electric power supply connector and the inlet. The adapter includes: an electric-power-receiving terminal connected to an electric power line on a side of the electric power supply connector; a connection line that connects the charging device and a device on a side of the vehicle via the electric power supply connector and the inlet, respectively; and a detection unit that detects a temperature of the electric-power-receiving terminal. The abnormality detection method includes: detecting the temperature of the electric-power-receiving terminal via the detection unit in a state where the adapter is connected to the electric power supply connector and the inlet; and generating a state, detectable by the device on the vehicle side, in the connection line in accordance with the temperature detected by the detection unit.

(10) An electric power supply system according to another embodiment includes: a charging device including an electric power supply connector; a vehicle including a storage battery and an inlet for electric power supply; and the adapter according to (1) above that connects the electric power supply connector and the inlet.

### Details of Embodiments of Present Disclosure

### [Configuration of Electric Power Supply System]

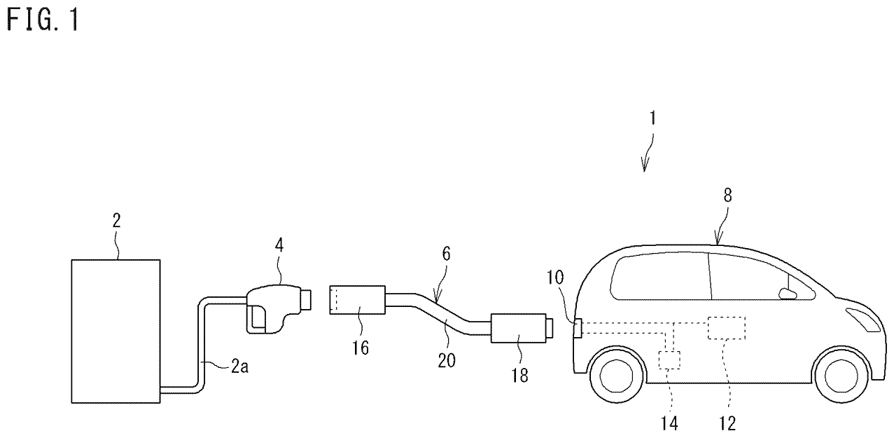

FIG. 1 is a diagram illustrating an example of an electric power supply system 1.

In FIG. 1, the electric power supply system 1 includes a charging stand (charging device) 2, an electric power supply connector 4, an adapter 6, and a vehicle 8.

The charging stand 2 outputs electric power to be supplied to the vehicle 8.

The electric power supply connector 4 is provided at the tip of a cable 2a extending from the charging stand 2. The electric power supply connector 4 is connected to the adapter 6. The electric power supply connector 4 of the present embodiment is an electric power supply connector conforming to CHAdeMO.

The vehicle 8 includes an inlet 10 for electric power supply, a battery (storage battery) 12, and a control device 14.

The adapter 6 is connected to the inlet 10. The inlet 10 has a function as a connector that receives electric power supplied from the connected adapter 6. The inlet 10 of the present embodiment is an inlet conforming to ChaoJi.

That is, the adapter 6 of the present embodiment is a conversion adapter that converts a connector conforming to the CHAdeMO standard into a connector connectable to an inlet conforming to the ChaoJi standard.

The control device 14 is connected to the inlet 10. The control device 14 includes a computer including a processor, a storage device, an input/output unit, a communication unit, and the like. The control device 14 has a function of performing charge control of the battery 12. Further, the control device 14 has a function of performing controller area network (CAN) communication with the charging stand 2. The control device 14 also has a function of exchanging signals related to connection confirmation between the electric power supply connector 4 and the inlet 10 with the charging stand 2 and signals related to the start, end, or the like of charging. The control device 14 performs charge control of the battery 12 by performing CAN communication and signal exchange with the charging stand 2.

The battery 12 supplies electric power for causing the vehicle 8 to travel to a motor for travel (not illustrated). The battery 12 is connected to the inlet 10. The battery 12 is charged by electric power supplied through the inlet 10.

The adapter 6 is interposed between the electric power supply connector 4 and the inlet 10, and has a function of connecting the two to enable electric power supply.

The adapter 6 includes an input connector 16, an output connector 18, and a cable 20.

The electric power supply connector 4 is connected to the input connector 16. Thus, the input connector 16 is a connector conforming to CHAdeMO.

The output connector 18 is connected to the inlet 10. Thus, the output connector 18 is a connector conforming to ChaoJi.

The cable 20 connects the input connector 16 and the output connector 18.

The electric power supply connector 4 and the inlet 10 of the vehicle 8 cannot be directly connected due to having different standards.

In contrast, the adapter 6 of the present embodiment has a function as a conversion adapter that connects the electric power supply connector 4 and the inlet 10 each having a different standard. Therefore, the adapter 6 of the present embodiment can be used to connect the electric power supply connector 4 and the inlet 10 of the vehicle 8, which each have a different standard, in a chargeable manner.

### Adapter of First Embodiment

A circuit configuration of a conversion connector for connecting a connector of a charger conforming to CHAdeMO to an inlet conforming to ChaoJi is disclosed in FIGS. 1 to 6 (Copyright: China Electric Council, Title: Control pilot circuit for backward compatibility between ChaoJi vehicle and CHAdeMO 2.0 and lower with CHAdeMO vehicle adaptor) of “White Paper of ChaoJi EV Charging Technology”, [online], [retrieved Feb. 1, 2021], Internet: https://www.cec.org.cn/upload/1/editor/1594869131179.pdf).

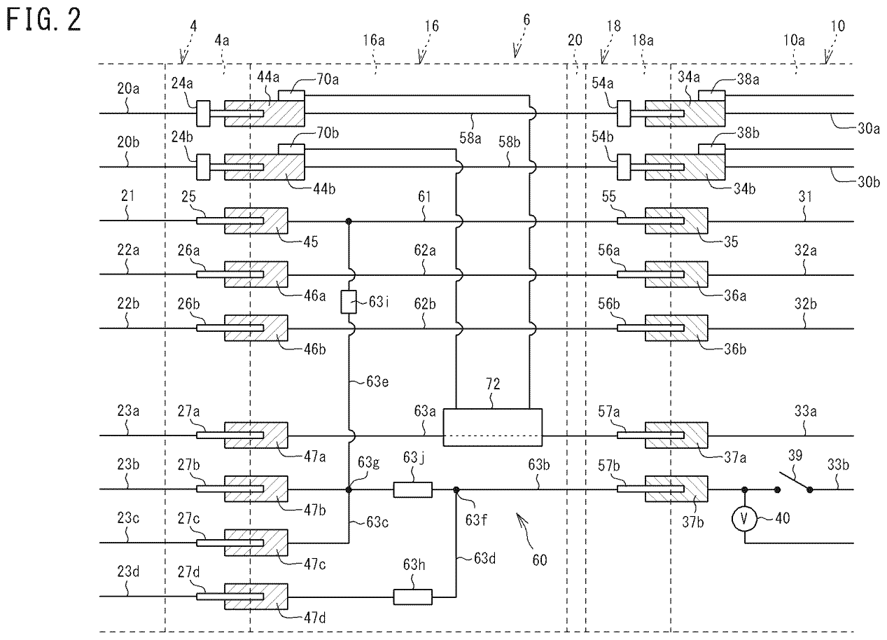

In FIGS. 2 to 4 below, the configuration of the portion related to the connector conversion refers to the configuration of FIGS. 1 to 6 of the above white paper.

FIG. 2 is a diagram illustrating the configuration of the adapter 6 according to the first embodiment.

In FIG. 2, the electric power supply connector 4 is illustrated on the left side of the drawing, and the inlet 10 is illustrated on the right side of the drawing. FIG. 2 illustrates a state where the adapter 6 connects the electric power supply connector 4 and the inlet 10. Therefore, the input connector 16 of the adapter 6 is connected to the electric power supply connector 4. The output connector 18 of the electric power supply connector 4 is connected to the inlet 10.

The electric power supply connector 4 includes electric power lines 20a, 20b, a ground line 21, communication lines 22a, 22b, and signal lines 23a, 23b, 23c, 23d. The electric power supply connector 4 further includes male terminals 24a. 24b, 25, 26a, 26b, 27a, 27b, 27c, 27d.

The electric power lines 20a, 20b are electric power lines for supplying electric power of the charging stand 2 to the outside. The electric power line 20a is a positive electric power line, and the electric power line 20b is a negative electric power line. One ends of the electric power lines 20a, 20b are connected to a charging stand. The other ends of the electric power lines 20a, 20b are connected to the male terminals 24a, 24b. That is, the male terminals 24a, 24b are electric power supply terminals.

One end of the ground line 21 is connected to a ground point (not illustrated) on the charging stand 2 side. The other end of the ground line 21 is connected to the male terminal 25.

The communication lines 22a, 22b are lines for CAN communication between a communication device on the charging stand 2 side and the control device 14 of the vehicle 8. The communication line 22a is a CANHigh line. The communication line 22b is a CANLow line. One ends of the communication lines 22a, 22b are connected to the communication device on the charging stand 2 side. The other ends of the communication lines 22a, 22b are connected to the male terminals 26a, 26b.

The signal lines 23a, 23b, 23c, 23d are lines for exchanging signals between the charging stand 2 (the device on the electric power supply connector 4 side) and the control device 14 (the device on the vehicle 8 side).

The signal lines 23a, 23d are charge start/stop signal lines. When a charge start switch is operated on the charging stand 2 side, the charging stand 2 supplies a predetermined voltage to the signal lines 23a, 23d as a signal for notifying the vehicle 8 side of the start of the charging sequence.

The signal line 23b is a signal line for connector connection confirmation. The charging stand 2 supplies a predetermined voltage to the signal line 23b as a signal indicating that electric power supply connector 4 has been connected to inlet 10.

The signal line 23c is a signal line for charge permission prohibition. The signal line 23c is a signal line for receiving a charge permission signal from the vehicle 8 side.

One ends of signal lines 23a, 23b, 23c, 23d are connected to the charging stand 2. The other ends of the signal lines 23a, 23b, 23c, 23d are connected to the male terminals 27a, 27b, 27c, 27d.

The electric power supply connector 4 includes a body 4a connectable to the input connector 16. The male terminals 24a, 24b, 25, 26a, 26b, 27a, 27b, 27c, 27d are provided in the body 4a. The male terminals 24a, 24b, 25, 26a, 26b, 27a, 27b, 27c, 27d are arranged in the body 4a according to the standard.

The inlet 10 includes electric power lines 30a, 30b, a ground line 31, communication lines 32a, 32b, and signal lines 33a, 33b. The inlet 10 further includes female terminals 34a, 34b, 35, 36a, 36b, 37a, 37b.

The electric power lines 30a, 30b are electric power lines for supplying electric power supplied from the charging stand 2 to the battery 12. The electric power line 30a is a positive electric power line, and the electric power line 30b is a negative electric power line. One ends of the electric power lines 30a, 30b are connected to the female terminals 34a, 34b. The other ends of the electric power lines 30a, 30b are connected to the battery 12.

One end of the ground line 31 is connected to the female terminal 35. The other end of the ground line 31 is connected to a grounding point (not illustrated) on the vehicle 8 side.

The communication lines 32a, 32b are lines for CAN communication between the communication device on the charging stand 2 side and the control device 14 of the vehicle 8. The communication line 32a is a CANHigh line. The communication line 32b is a CANLow line. One ends of the communication lines 32a, 32b are connected to the female terminals 36a. 36b. The other ends of the communication lines 32a, 32b are connected to the control device 14.

The signal lines 33a, 33b are lines for exchanging signals between the device on the charging stand 2 side and the device on the vehicle 8 side.

The signal lines 33a, 33b are signal lines for receiving a signal for confirming connection between the electric power supply connector 4 and the inlet 10. The control device 14 monitors a voltage supplied to the signal line 33a as a signal transmitted from the charging stand 2. The control device 14 confirms that the electric power supply connector 4 and the inlet 10 are normally connected based on the voltage of the signal line 33a.

One ends of the signal lines 33a, 33b are connected to the female terminals 37a, 37b. The other ends of the signal lines 33a, 33b are connected to the control device 14.

The inlet 10 includes a body 10a connectable to the output connector 18. The female terminals 34a, 34b, 35, 36a, 36b, 37a, 37b are provided in the body 10a. The female terminals 34a. 34b, 35, 36a, 36b, 37a, 37b are disposed in the body 10a according to the standard.

The inlet 10 further includes temperature sensors 38a, 38b. The temperature sensors 38a, 38b are, for example, thermistors. The temperature sensor 38a is provided in the female terminal 34a. The temperature sensor 38b is provided in the female terminal 34b.

The temperature sensors 38a, 38b are connected to the control device 14 of the vehicle 8. Outputs of the temperature sensors 38a, 38b are provided to the control device 14.

The control device 14 has a function of performing a process to stop charging in accordance with outputs from the temperature sensors 38a, 38b. For example, during charging, when the outputs of the temperature sensors 38a, 38b are compared with a predetermined threshold and it is determined that the outputs of the temperature sensors 38a, 38b are equal to or more than the predetermined threshold, the control device 14 stops charging. Note that the temperature indicated by the predetermined threshold is, for example, 90° C. That is, when the temperature of the female terminals 34a, 34b becomes higher than 90° C., the control device 14 stops charging.

The signal line 33b is provided with a switch 39 and a voltage sensor 40. The switch 39 is intermittently connected between the female terminal 37b and the control device 14.

The voltage sensor 40 is connected between the female terminal 37b and the switch 39 via a branch path. The voltage sensor 40 is connected to the control device 14.

The control device 14 determines the presence or absence of the adapter 6 and the charging method of the charging stand as the electric power supply source based on the output of the voltage sensor 40.

When charging is to be started, the control device 14 switches the switch 39 from a closed-circuit state to an open-circuit state.

The input connector 16 of the adapter 6 includes female terminals 44a, 44b, 45, 46a, 46b, 47a, 47b, 47c, 47d.

As will be described later, the female terminals 44a, 44b, 45, 46a, 46b, 47a, 47b, 47c, 47d can be connected to the male terminals 24a, 24b, 25, 26a, 26b, 27a, 27b, 27c, 27d of the electric power supply connector 4.

Note that the female terminals 44a, 44b are connected to the male terminals 24a, 24b connected to the electric power lines 20a, 20b of the electric power supply connector 4. That is, the female terminals 44a, 44b are electric-power-receiving terminals. In the following description, the female terminals 44a, 44b may be referred to as electric-power-receiving terminals 44a, 44b.

The output connector 18 of the adapter 6 includes male terminals 54a, 54b, 55, 56a, 56b, 57a, 57b.

The male terminals 54a, 54b, 55, 56a, 56b, 57a, 57b can be connected to the female terminals 34a, 34b, 35, 36a, 36b, 37a, 37b of the inlet 10 as described later.

The adapter 6 includes electric power lines 58a, 58b and a connection line 60. The connection line 60 is a line group for connecting the charging stand 2 and the device on the vehicle 8 side. The connection line 60 connects the charging stand 2 and the device on the vehicle 8 side via the electric power supply connector 4 and the inlet 10, respectively. The connection line 60 includes a ground line 61, communication lines 62a, 62b, and signal lines 63a, 63b, 63c, 63d, 63e.

The electric power lines 58a, 58b constitute a part of a line for supplying electric power supplied from the charging stand 2 to the vehicle 8 side. The electric power line 58a is a positive electric power line, and the electric power line 58b is a negative electric power line. One ends of the electric power lines 58a, 58b are connected to the electric-power-receiving terminals 44a, 44b. The other ends of the electric power lines 58a, 58b are connected to the male terminals 54a, 54b.

The ground line 61 constitutes a part of a line for connecting a ground point on the charging stand 2 side and a ground point on the vehicle 8 side. One end of the ground line 61 is connected to the female terminal 45. The other end of the ground line 61 is connected to the male terminal 55.

The communication lines 62a, 62b each constitute a part of a line used for CAN communication between the communication device on the charging stand 2 side and the control device 14 of the vehicle 8. The communication line 62a is a CANHigh line. The communication line 62b is a CANLow line. One ends of the communication lines 62a, 62b are connected to the female terminals 46a, 46b. The other ends of the communication lines 62a, 62b are connected to the male terminals 56a, 56b.

The signal lines 63a, 63b each constitute a part of a line for exchanging signals with the charging stand 2. One ends of the signal lines 63a, 63b are connected to the female terminals 47a, 47b. The other ends of the signal lines 63a, 63b are connected to the male terminals 57a and 57b.

The signal lines 63b, 63c, 63d, 63e are lines for matching signals handled by the electric power supply connector 4 and the inlet 10.

One end of the signal line 63c is connected to the female terminal 47c. The other end of the signal line 63c is connected to the signal line 63b.

One end of the signal line 63d is connected to the female terminal 47d. The other end of the signal line 63d is connected to the signal line 63b.

A connection point 63f is located closer to the inlet 10 than a connection point 63g. The connection point 63f is a portion of the signal line 63b to which the other end of the signal line 63d is connected. The connection point 63g is a portion of the signal line 63b to which the other end of the signal line 63c is connected.

One end of the signal line 63e is connected to the connection point 63g. The other end of the signal line 63e is connected to the ground line 61.

The signal lines 63d, 63e are provided with resistance elements 63h, 63i. A resistance element 63j is connected between the connection point 63f and the connection point 63g of the signal line 63b.

The signal lines 63b, 63b, 63c, 63d, 63e and the resistance elements 63h, 631, 63j are configured to be able to match and connect the signal lines 23b, 23c, 23d of the electric power supply connector 4 and the signal line 33b of the inlet 10.

The input connector 16 includes a body 16a (first connection) connectable to the electric power supply connector 4. The female terminals 44a, 44b, 45, 46a, 46b, 47a, 47b, 47c, 47d are provided in the body 16a. The female terminals 44a, 44b, 45, 46a, 46b, 47a, 47b, 47c, 47d are arranged in the body 16a according to the standard.

As a result, when the electric power supply connector 4 and the input connector 16 are connected, the female terminals 44a, 44b, 45, 46a, 46b, 47a, 47b, 47c, 47d and the male terminals 24a, 24b, 25, 26a, 26b, 27a, 27b, 27c, 27d of the electric power supply connector 4 are connected.

The output connector 18 includes a body 18a (second connection) connectable to the inlet 10. The male terminals 54a, 54b, 55, 56a, 56b, 57a, 57b are provided in the body 18a. The male terminals 54a, 54b, 55, 56a, 56b, 57a, 57b are arranged in the body 18a according to the standard.

As a result, when the output connector 18 and the inlet 10 are connected, the male terminals 54a, 54b, 55, 56a, 56b, 57a, 57b and the female terminals 34a, 34b, 35, 36a, 36b, 37a, 37b of the inlet 10 are connected.

When the electric power supply connector 4 and the input connector 16 are connected and the output connector 18 and the inlet 10 are connected, the electric power lines 20a, 20b of the electric power supply connector 4 and the electric power lines 30a, 30b of the inlet 10 are connected to each other. Similarly, the ground line 21 and the ground line 31 are connected to each other. Further, the communication lines 22a, 22b and the communication lines 32a, 32b are connected to each other. In addition, the signal lines 23a, 23b and the signal lines 33a, 33b are connected to each other.

As described above, the adapter 6 of the present embodiment connects the electric power supply connector 4 and the inlet 10, which each have a different standard, between the body 16a and the body 18a.

The adapter 6 of the present embodiment includes temperature sensors 70a, 70b and an error generation unit 72.

Hereinafter, the temperature sensors 70a, 70b and the error generation unit 72 will be described.

### [Error Generation Unit]

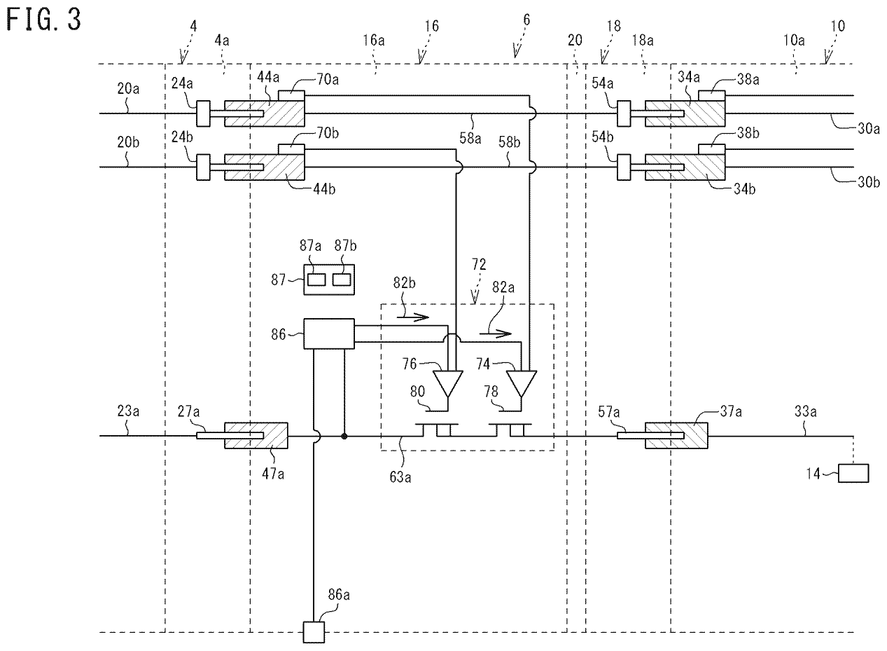

FIG. 3 is a diagram illustrating the main part in FIG. 2. FIG. 3 illustrates the temperature sensors 70a, 70b, the error generation unit 72, and portions related thereto.

The adapter 6 includes a power supply circuit 86. The power supply circuit 86 is connected to the signal line 63a, generates a drive voltage necessary for the temperature sensors 70a, 70b and the error generation unit 72 from the voltage of the signal line 63a, and applies the generated voltage to the temperature sensors 70a, 70b and the error generation unit 72.

The power supply circuit 86 includes a reset switch 86a. The reset switch 86a is provided on the outer surface of the body 16a. The reset switch 86a has a function of temporarily stopping the supply of the drive voltage by receiving an operation input from the outside.

The temperature sensors 70a, 70b are detection units for detecting the temperatures of the electric-power-receiving terminals 44a, 44b. The temperature sensors 70a, 70b are, for example, thermistors.

The temperature sensor 70a is provided at the electric-power-receiving terminal 44a. The temperature sensor 70b is provided at the electric-power-receiving terminal 44b.

The temperature sensors 70a, 70b are connected to the error generation unit 72. The outputs of the temperature sensors 70a, 70b are provided to the error generation unit 72.

A voltage is applied from the power supply circuit 86 to the temperature sensors 70a, 70b. Based on this, the temperature sensors 70a, 70b apply voltages corresponding to the temperatures of the electric-power-receiving terminals 44a, 44b to the error generation unit 72 as outputs.

The error generation unit 72 has a function of generating an open-circuit state detectable by the control device 14 in the signal line 63a in accordance with the outputs of the temperature sensors 70a, 70b.

The error generation unit 72 includes a first comparator 74, a second comparator 76, a first switch 78, and a second switch 80.

The first switch 78 is a semiconductor switch, and is formed of, for example, a metal-oxide-semiconductor field-effect transistor (MOSFET).

The first switch 78 is provided on the signal line 63a and has a function of interrupting the signal line 63a. The gate voltage of the first switch 78 is applied from the first comparator 74. Therefore, the open and close of the first switch 78 is controlled by the output from the first comparator 74.

The first switch 78 is a normally-on type. Therefore, when the gate voltage (gate-source voltage) applied from the first comparator 74 is 0 volt, the first switch 78 brings the signal line 63a into a closed-circuit state (connected state).

On the other hand, when the gate voltage applied from the first comparator 74 is a predetermined negative voltage, the first switch 78 brings the signal line 63a into the open-circuit state (disconnected state).

The output voltage of the temperature sensor 70a and a reference voltage 82a are applied to the first comparator 74. The reference voltage 82a is applied from the power supply circuit 86.

The first comparator 74 compares the output voltage of the temperature sensor 70a with the reference voltage 82a.

When the output voltage of the temperature sensor 70a is lower than the reference voltage 82a, the first comparator 74 sets the gate voltage to be applied to the first switch 78 to 0 volt.

When the output voltage of the temperature sensor 70a is higher than the reference voltage 82a, the first comparator 74 sets the gate voltage to be applied to the first switch 78 to a voltage (negative voltage) for bringing the first switch 78 into the open-circuit state.

The temperature sensors 70a, 70b are thermistors as described above, and the resistance value decreases as the temperature rises. Therefore, the output voltages of the temperature sensors 70a, 70b increase as the temperature rises.

That is, when the temperature indicated by the output voltage of the temperature sensor 70a is lower than the temperature indicated by the reference voltage 82a, the first comparator 74 sets the gate voltage to be applied to the first switch 78 to 0 volt. Thus, in this case, the first switch 78 brings the signal line 63a into the closed-circuit state.

On the other hand, when the temperature indicated by the output voltage of the temperature sensor 70a is higher than the temperature indicated by the reference voltage 82a, the first comparator 74 sets the gate voltage to be applied to the first switch 78 to a voltage for bringing the first switch 78 into the open-circuit state. Thus, in this case, the first switch 78 brings the signal line 63a into the open-circuit state.

In this manner, the first switch 78 generates the open-circuit state in the signal line 63a by disconnecting the signal line 63a.

The second switch 80 includes a MOSFET similar to the first switch 78. The second switch 80 is provided on the signal line 63a and has a function of interrupting the signal line 63a. The gate voltage of the second switch 80 is applied from the second comparator 76. Therefore, the open and close of the second switch 80 is controlled by the output from the second comparator 76.

The second switch 80 is also a normally-on type.

The output voltage of the temperature sensor 70b and a reference voltage 82b are applied to the second comparator 76. The reference voltage 82b is applied from the power supply circuit 86.

The second comparator 76 compares the output voltage of the temperature sensor 70b with the reference voltage 82b, and controls the second switch 80 similarly to the first comparator 74.

When the temperature indicated by the output voltage of the temperature sensor 70b is lower than the temperature indicated by the reference voltage 82b, the second comparator 76 sets the gate voltage to be applied to the second switch 80 to 0 volt. Thus, in this case, the second switch 80 brings the signal line 63a into the closed-circuit state.

On the other hand, when the temperature indicated by the output voltage of the temperature sensor 70b is higher than the temperature indicated by the reference voltage 82b, the second comparator 76 sets the gate voltage to be applied to the second switch 80 to a voltage for bringing the second switch 80 into the open-circuit state. Thus, in this case, the second switch 80 brings the signal line 63a into the open-circuit state.

In this manner, the second switch 80 generates the open-circuit state in the signal line 63a by disconnecting the signal line 63a.

Hereinafter, a description will be given of the operation of the error generation unit 72 when the electric power supply connector 4 and the adapter 6 are connected, the adapter 6 and the inlet 10 are connected, and the battery 12 is being charged.

A predetermined voltage is supplied to the signal line 23a by the charging stand 2 as a signal for notifying the vehicle 8 side that the charging sequence has been started. Until the charging sequence ends, the charging stand 2 continues to supply the voltage to the signal line 23a. That is, the voltage supplied to the signal line 23a is a notification signal for notifying the start and stop of charging.

The signal line 63a of the adapter 6 is connected to the signal line 23a. The signal line 33a of the inlet 10 is connected to the signal line 63a of the adapter 6. Therefore, when charging is normally performed, the voltage (notification signal) from the charging stand 2 is also applied to the signal line 33a.

As described above, the control device 14 of the vehicle 8 monitors the voltage (notification signal) of the signal line 33a to confirm that the electric power supply connector 4 and the inlet 10 are normally connected.

When the voltage of the signal line 33a is a predetermined voltage, the control device 14 determines that the connection is normal. When the voltage of the signal line 33a becomes a reference voltage (e.g., 0 volts), the control device 14 determines that an error has occurred between the electric power supply connector 4 and the inlet 10, and performs a process to stop charging.

For example, assume that the temperatures indicated by the reference voltages 82a, 82b are 90° C. The temperatures indicated by the reference voltages 82a, 82b are thresholds for determining whether the electric-power-receiving terminals 44a, 44b have temperature abnormalities. When the temperatures of the electric-power-receiving terminals 44a, 44b are lower than 90° C., both the switches 78, 80 bring the signal line 63a into the closed-circuit state.

In this case, a voltage from the signal line 23a of the electric power supply connector 4 is applied to the signal line 33a of the inlet 10 through the signal line 63a.

Thus, the charging of the battery 12 is continued.

On the other hand, when the temperature of the electric-power-receiving terminal 44a is higher than 90° C., the first switch 78 brings the signal line 63a into the open-circuit state.

In this case, since the signal line 63a of the adapter 6 is disconnected, the voltage from the charging stand 2 is not applied to the signal line 33a of the inlet 10.

When detecting that the voltage from the charging stand 2 has been interrupted, the control device 14 of the vehicle 8 determines that an error has occurred between the electric power supply connector 4 and the inlet 10, and performs the process to stop charging.

The same applies to a case where the temperature of the electric-power-receiving terminal 44b is higher than 90° C., and the second switch 80 brings the signal line 63a into the open-circuit state. The control device 14 of the vehicle 8 determines that an error has occurred between the electric power supply connector 4 and the inlet 10, and performs the process to stop charging.

As described above, the error generation unit 72 brings the signal line 63a into the open-circuit state in accordance with the temperatures of the electric-power-receiving terminals 44a, 44b, and generates a pseudo disconnection error in the signal line 63a.

With this configuration, when the temperature of at least one of the electric-power-receiving terminal 44a or 44b becomes higher than 90° C. and the temperature abnormality of the electric-power-receiving terminal 44a or 44b is detected, the signal line 63a is brought into the open-circuit state, whereby a pseudo disconnection error is generated in the signal line 63a, and the occurrence of the temperature abnormality in the electric-power-receiving terminal 44a or 44b of the adapter 6 can be detected by the control device 14 of the vehicle 8 through the signal line 33a.

That is, when the temperature abnormality of the electric-power-receiving terminal 44a or 44b is detected, a state detectable by the control device 14 is generated in the connection line, and the control device 14 can be caused to detect that the temperature abnormality has occurred in the electric-power-receiving terminal 44a or 44b.

As a result, the temperature abnormality of the electric-power-receiving terminal 44a or 44b can be detected without changing the configurations of the charging stand 2 and the vehicle 8 sides.

The signal line 63a interrupted by the error generation unit 72 of the present embodiment is connected to the signal line 23a that is a charge start/stop signal line to which the notification signal described above is provided.

As described above, when the predetermined voltage from the charging stand 2, which is the notification signal, is stopped, the control device 14 of the vehicle 8 executes the charging stop process.

Therefore, as in the present embodiment, when a temperature abnormality of the electric-power-receiving terminal 44a or 44b is detected based on each of the outputs of the temperature sensors 70a, 70b (detection units), the signal line 63a is brought into an open-circuit state, whereby a predetermined voltage from the charging stand 2 can be interrupted. As a result, it is possible to cause the control device 14 to execute the charging stop process.

Since the error generation unit 72 of the present embodiment includes the switches 78, 80 which are semiconductor switches that connect and disconnect the signal line 63a, by opening the switches 78, 80 in accordance with the outputs of the temperature sensors 70a, 70b, an open-circuit state that can be detected by the control device 14 can be generated in the signal line 63a.

Since these switches 78, 80 are normally-on type semiconductor switches, the conduction state of the signal line 63a can be maintained without applying a drive voltage to the switches 78, 80 provided in the signal line 63a. In addition, it is possible to suppress electric power consumption in the case of maintaining the conduction state, which is a state that should originally be. Moreover, by connecting the adapter 6 to the electric power supply connector 4 and the inlet 10, the adapter 6 can connect the electric power supply connector 4 and the inlet 10 in a chargeable manner even if a driving voltage is not applied to the switches 78, 80 for some reason.

The adapter 6 of the present embodiment further includes a notification device 87.

The notification device 87 includes a processing unit 87a and a wireless transmission unit 87b. The processing unit 87a is formed of a computer including a processor, a storage device, and the like, or a device equivalent thereto. The processing unit 87a has a function of monitoring gate voltages and the like of the switches 78, 80, and outputting a notification regarding the temperature abnormalities of the electric-power-receiving terminals 44a, 44b to the outside when the switches 78, 80 operate to disconnect the signal line 63a.

The wireless transmission unit 87b can wirelessly communicate with an external device, and outputs the notification to the external device by wireless communication. Note that the wireless communication includes Wi-Fi (registered trademark), Bluetooth (registered trademark), mobile wireless communication, and the like.

This enables the external device to be notified of the temperature abnormality of the electric-power-receiving terminals 44a, 44b.

In the adapter 6 of the present embodiment, the power supply circuit 86 includes the reset switch 86a.

Therefore, when the temperatures of the electric-power-receiving terminals 44a, 44b do not rise, for example, even if the switches 78, 80 malfunction due to the influence of noise or the like and the signal line 63a is disconnected, the switches 78, 80 can be reset to the connected state by the reset switch 86a temporarily stopping the power supply circuit 86 from supplying the drive voltage to restore the gate voltages of the comparators 74, 76. This enables the adapter 6 to be restored to an available state again.

When the temperatures of the electric-power-receiving terminals 44a, 44b rise in a case where the adapter 6 is restored to the available state again and then charging is started again, the signal line 63a is disconnected again. Therefore, even if adapter 6 is restored and charging is started again, no problem occurs.

### Adapter of Second Embodiment

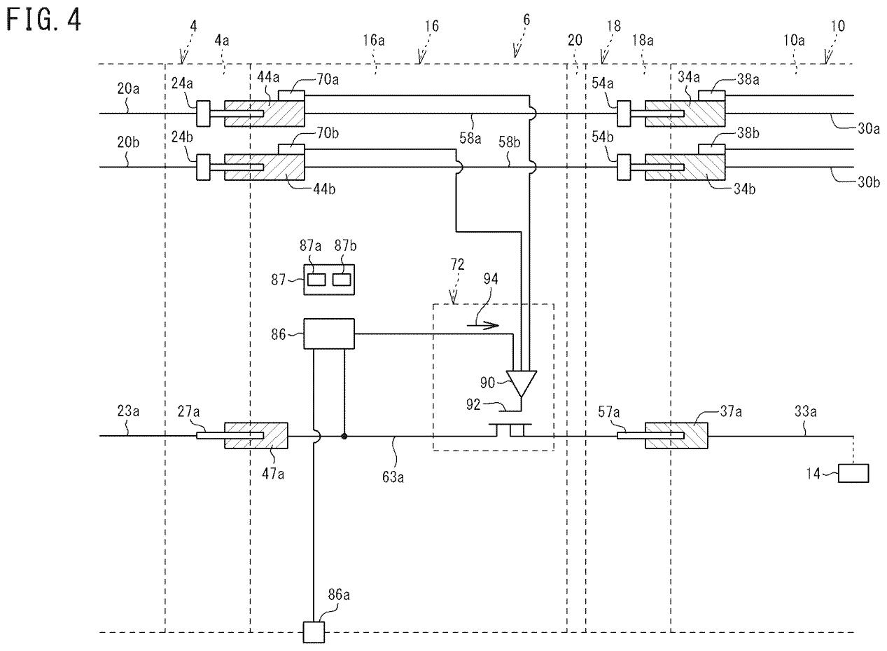

FIG. 4 is a diagram illustrating the main part of an adapter 6 according to a second embodiment.

An error generation unit 72 of the present embodiment is different from that of the first embodiment in including a three-input comparator 90 and a switch 92.

The switch 92 is a semiconductor switch similar to the switches 78, 80 of the first embodiment.

The gate voltage of the switch 92 is applied from the comparator 90. Thus, the switch 92 is controlled to open and close by the output from the comparator 90.

The output voltage of the temperature sensor 70a, the output voltage of the temperature sensor 70b, and a reference voltage 94 are applied to the comparator 90. The reference voltage 94 is applied from the power supply circuit 86.

The comparator 90 compares the higher one of the output voltage of the temperature sensor 70a and the output voltage of the temperature sensor 70b with the reference voltage 94. When the output voltages of the temperature sensors 70a, 70b are lower than the reference voltage 94, the comparator 90 sets the gate voltage to be applied to the switch 92 to 0 volt.

When the output voltages of the temperature sensors 70a, 70b are higher than the reference voltage 94, the comparator 90 sets the gate voltage to be applied to the switch 92 to a voltage for bringing the switch 92 into the open-circuit state.

Therefore, when the temperatures indicated by the output voltages of the temperature sensors 70a, 70b are lower than the temperature indicated by the reference voltage 94, the comparator 90 sets the gate voltage to be applied to the switch 92 to 0 volt. Thus, in this case, the switch 92 brings the signal line 63a into the closed-circuit state.

On the other hand, when the temperatures indicated by the output voltages of the temperature sensors 70a, 70b are higher than the temperature indicated by the reference voltage 94, the comparator 90 sets the gate voltage to be applied to the switch 92 to a voltage for bringing the switch 92 into the open-circuit state. Thus, in this case, the switch 92 brings the signal line 63a into the open-circuit state.

Similarly to the first embodiment, when the temperature of at least one of the electric-power-receiving terminal 44a or 44b becomes higher than the predetermined temperature, the signal line 63a is brought into the open-circuit state, whereby the error generation unit 72 of the present embodiment generates a pseudo disconnection error in the signal line 63a. Therefore, it is possible to cause the control device 14 of the vehicle 8 to detect that the electric-power-receiving terminals 44a, 44b of the adapter 6 become higher than 90° C. and cause the control device 14 to execute the charging stop process.

### [Others]

The embodiments disclosed herein are to be considered as illustrative and non-restrictive in every respect.

In each of the above embodiments, the case where the temperature sensors 70a, 70b are provided in the electric-power-receiving terminals 44a, 44b has been exemplified, but the temperature sensors may also be provided in the male terminals 54a, 54b to which the electric power lines 58a, 58b are connected, and the signal line 63a may be interrupted in accordance with the outputs of the temperature sensors.

In each of the above embodiments, the case where the normally-on type MOSFET is used for each of the switches 78, 80, 92 has been exemplified, but a normally-off type MOSFET may be used.

A relay switch including a mechanical contact or the like may be used as each of the switches 78, 80, 92.

In each of the above embodiments, the case where the switches 78, 80, 92 of the error generation unit 72 are provided on the signal line 63a to which the notification signal is provided has been exemplified. However, the switches 78, 80, 92 may be provided on the communication lines 62a, 62b. In a case where the switches 78, 80, 92 are provided on the communication lines 62a, 62b, when the switches 78, 80, 92 bring the communication lines 62a, 62b into the open-circuit state, the control device 14 of the vehicle 8 determines that the CAN communication with the charging stand 2 has been disconnected, and executes the charging stop process.

However, when the switches 78, 80, 92 are provided in the signal line 63a as in the present embodiment, charging can be stopped without interrupting CAN communication.

In the present embodiment, the adapter 6 connected between the electric power supply connector 4 conforming to CHAdeMO and the inlet 10 conforming to ChaoJi has been shown, but the present invention is not limited thereto.

For example, the adapter 6 may be configured to be connected between the electric power supply connector 4 conforming to ChaoJi and the inlet 10 conforming to CHAdeMO, or the adapter 6 may be configured to be connected between a connector and an inlet conforming to other different standards. For example, the adapter 6 may be configured to be connected between the electric power supply connector 4, such as GBT or CCS, and the inlet 10.

Moreover, the adapter 6 may be configured to be connected between the electric power supply connector 4 and the inlet 10 of the same standard. For example, the adapter 6 may be configured to be connected between the electric power supply connector 4 conforming to CHAdeMO and the inlet 10 conforming to CHAdeMO.

The scope of the present invention is shown not by the meanings described above but by the scope of the claims and is intended to include the meanings equivalent to the scope of the claims and all modifications within the scope.

### REFERENCE SIGNS LIST

1 electric power supply system
2 charging stand
2a cable
4 electric power supply connector
4a body
6 adapter
8 vehicle
10 inlet
10a body
12 battery
14 control device
16 input connector
16a body
18 output connector
18a body
20 cable
20a, 20b electric power line
21 ground line
22a, 22b communication line
23a, 23b, 23c, 23d signal line
24a, 24b, 25, 26a, 26b, 27a, 27b, 27c, 27d male terminal
30a, 30b electric power line
31 ground line
32a, 32b communication line
33a, 33b signal line
34a, 34b, 35, 36a, 36b, 37a, 37b female terminal
38a, 38b temperature sensor
39 switch
40 voltage sensor
44a, 44b, 45, 46a, 46b, 47a, 47b, 47c, 47d female terminal
54a, 54b, 55, 56a, 56b, 57a, 57b male terminal
58a, 58b electric power line
60 connection line
61 ground line
62a, 62b communication line
63a, 63b, 63c, 63d, 63e signal line
63f, 63g connection point
63h, 63i, 63j resistance element
70a, 70b temperature sensor
72 error generation unit
74 first comparator
76 second comparator
78 first switch
80 second switch
82a reference voltage
82b reference voltage
86 power supply circuit
86a reset switch
87 notification device
87a processing unit
87b wireless transmission unit
90 comparator
92 switch
94 reference voltage

1. An adapter that is disposed between an electric power supply connector of a charging device and an inlet for electric power supply included in a vehicle in which a storage battery is installed, the adapter connecting the electric power supply connector and the inlet, the adapter comprising:
an electric-power-receiving terminal connected to an electric power line of the electric power supply connector;
a connection line that connects the charging device and a device on a side of the vehicle via the electric power supply connector and the inlet, respectively;
a detection unit that detects a temperature of the electric-power-receiving terminal; and
an error generation unit that generates a state, detectable by the device on the vehicle side, in the connection line in accordance with an output of the detection unit.

2. The adapter according to claim 1, wherein the connection line includes a signal line to which a notification signal is provided to notify start and stop of charging, the notification signal being transmitted from the charging device to the device on the vehicle side.

3. The adapter according to claim 1, wherein the error generation unit includes a switch to interrupt the connection line and generates an open-circuit state, detectable by the device on the vehicle side, in the connection line by bringing the switch into an open state in accordance with an output of the detection unit.

4. The adapter according to claim 3, wherein the switch includes a semiconductor switch.

5. The adapter according to claim 3, wherein
the detection unit includes a thermistor,
the error generation unit further includes a comparator that compares an output voltage of the thermistor with a predetermined threshold voltage, and
when the output voltage of the thermistor becomes larger than the predetermined threshold voltage, the comparator operates the switch to disconnect the connection line.

6. The adapter according to claim 3, further comprising a notification unit that outputs a notification regarding a temperature abnormality of the electric-power-receiving terminal to an external device when the switch operates to disconnect the connection line.

7. The adapter according to claim 6, wherein the notification unit includes a wireless transmission unit that wirelessly transmits the notification to the external device.

8. The adapter according to claim 1, wherein
the electric power supply connector and the inlet each have a different standard,
the adapter further comprises:
a first connection connectable to the electric power supply connector; and
a second connection connectable to the inlet, and
the adapter connects the electric power supply connector and the inlet, each having a different standard, between the first connection and the second connection.

9. An abnormality detection method for an adapter that is disposed between an electric power supply connector of a charging device and an inlet for electric power supply included in a vehicle in which a storage battery is installed, the adapter connecting the electric power supply connector and the inlet,
the adapter including
an electric-power-receiving terminal connected to an electric power line on a side of the electric power supply connector,
a connection line that connects the charging device and a device on a side of the vehicle via the electric power supply connector and the inlet, respectively, and
a detection unit that detects a temperature of the electric-power-receiving terminal,
the abnormality detection method comprising:
detecting the temperature of the electric-power-receiving terminal via the detection unit in a state where the adapter is connected to the electric power supply connector and the inlet; and
generating a state, detectable by the device on the vehicle side, in the connection line in accordance with the temperature detected by the detection unit.

10. An electric power supply system comprising:
a charging device including an electric power supply connector;
a vehicle including a storage battery and an inlet for electric power supply; and
the adapter according to claim 1 that connects the electric power supply connector and the inlet.
